(19) United States
(12) Patent Application Publication
(10) Pub. No.: US 2026/0177896 A1
(43) Pub. Date: Jun. 25, 2026

(54) PROJECTION DEVICE

(71) Applicant: Coretronic Corporation, Hsin-Chu (TW)

(72) Inventors: Yao-Lei Huang, Hsin-Chu (TW); Tsu-Yen Fang, Hsin-Chu (TW)

(73) Assignee: Coretronic Corporation, Hsin-Chu (TW)

(21) Appl. No.: 19/387,634

(22) Filed: Nov. 13, 2025

(30) Foreign Application Priority Data
Dec. 19, 2024 (CN) 202411878668.6

(51) Int. Cl. G03B 21/14; G03B 17/54; G03B 21/20; G03B 29/00

(52) U.S. Cl. CPC G03B 21/142; G03B 17/54; G03B 21/208; G03B 29/00

(57) ABSTRACT

A projection device includes an optical engine module, a projection lens module, a sensor and at least one processor is provided. The projection lens module is disposed on a transmission path of the image beam from the optical engine module and is configured to project the image beam out of the projection device. The projection lens module includes a projection lens and a lens adjustment module configured to adjust a position of the projection lens. The sensor is configured to sense an orientation status of the projection device. The at least one processor is coupled to the sensor and coupled to at least one of the optical engine module and the lens adjustment module. The at least one processor is configured to adjust a control signal provided to at least one of the optical engine module and the lens adjustment module according to the orientation status of the projection device.

### CROSS-REFERENCE TO RELATED APPLICATION

This application claims the priority benefit of China application serial no. 202411878668.6 filed on December 19, 2024. The entirety of the above-mentioned patent application is hereby incorporated by reference herein and made a part of this specification.

### BACKGROUND

### Technical Field

The invention relates to a projection device.

### Description of Related Art

When an orientation status of a projection device changes, an optical engine module in the projection device will be affected by gravity, resulting in distortion, blur, and/or offset of a projected image. In addition, a lens adjustment module in the projection device will also be affected by gravity, which leads to problems such as reduced operational smoothness, reduced stability of a projection lens, wear and tear of a mechanical structure, and/or a shortened service life.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a projection device, which helps to mitigate one or a plurality of problems caused by changes in an orientation status.

Additional aspects and advantages of the present invention will be set forth in the description of the techniques disclosed in the present invention.

In order to achieve one or a portion of or all of the objects or other objects, an embodiment of the invention provides a projection device including an optical engine module, a projection lens module, a sensor and at least one processor. The optical engine module is configured to provide an image beam. The projection lens module is disposed on a transmission path of the image beam from the optical engine module and is configured to project the image beam out of the projection device. The projection lens module includes a projection lens and a lens adjustment module. The lens adjustment module is configured to adjust a position of the projection lens. The sensor is configured to sense an orientation status of the projection device. The at least one processor is coupled to the sensor and coupled to at least one of the optical engine module and the lens adjustment module. The at least one processor is configured to adjust a control signal provided to at least one of the optical engine module and the lens adjustment module according to the orientation status of the projection device.

Based on the above description, embodiments of the invention have at least one of the following advantages or effects. In an embodiment of the invention, the at least one processor adjusts the control signal provided to at least one of the optical engine module and the lens adjustment module according to the orientation status of the projection device, which mitigates a negative influence on the optical engine module and/or the lens adjustment module caused by changes in the orientation status.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a projection device according to some embodiments of the invention.

FIG. 2 is a block diagram of another projection device according to some embodiments of the invention.

FIG. 3 and FIG. 4 are respectively schematic diagrams of two orientation statuses of the projection device in FIG. 2.

FIG. 5 is a schematic diagram of a control signal provided to a driving element of an actuator.

FIG. 6 is a block diagram of another projection device according to some embodiments of the invention.

FIG. 7 and FIG. 8 are respectively schematic diagrams of two orientation statuses of the projection device in FIG. 6.

FIG. 9 is a schematic diagram of control signals provided to driving motors of a lens adjustment module.

FIG. 10 is a block diagram of yet another projection device according to some embodiments of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

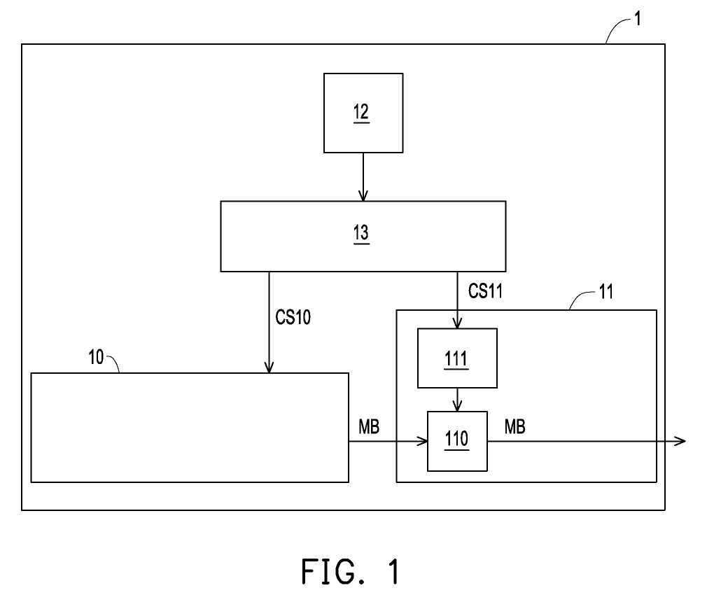

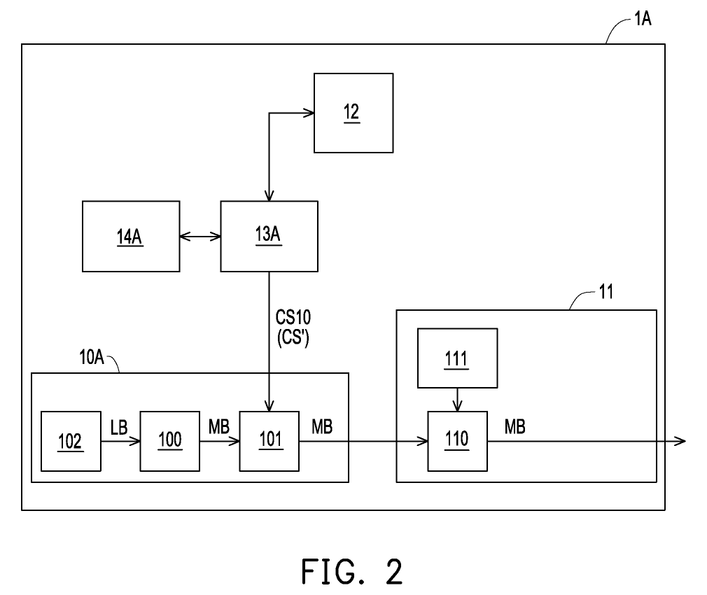

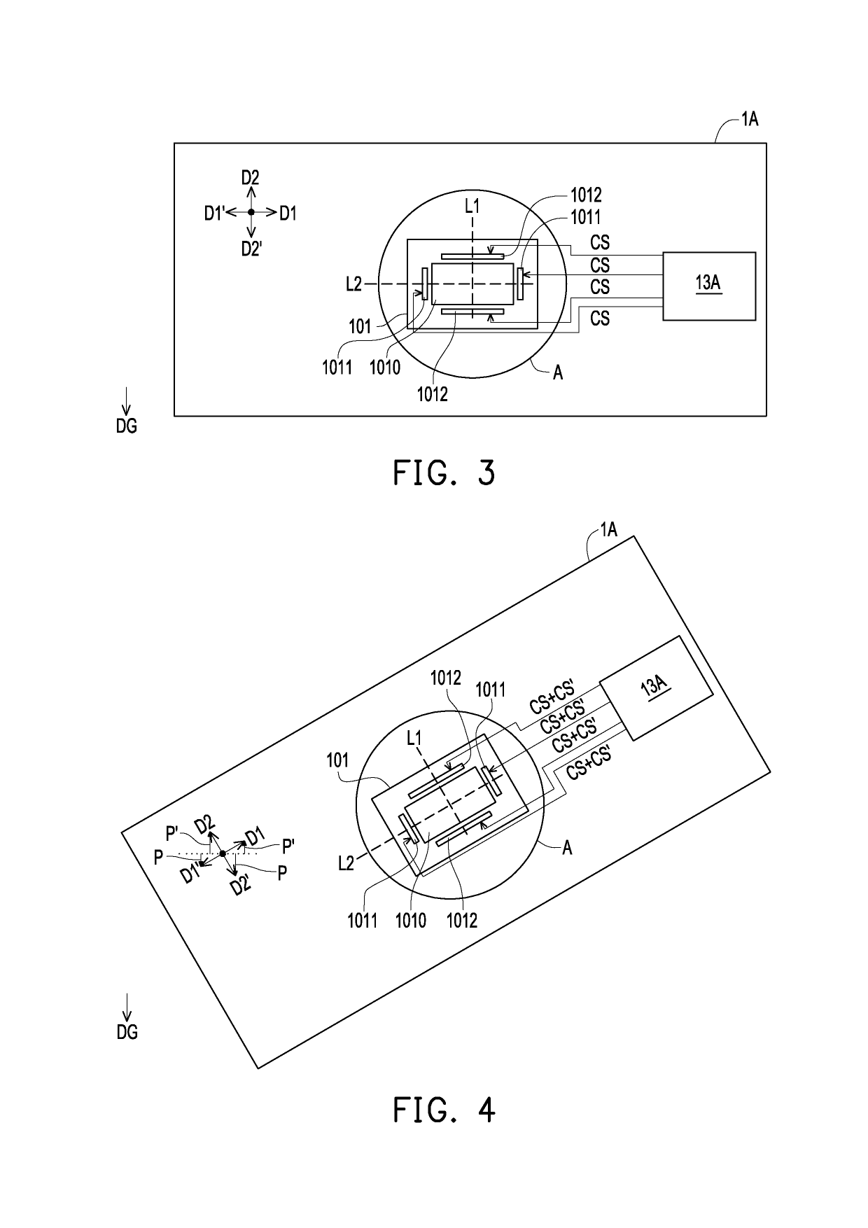

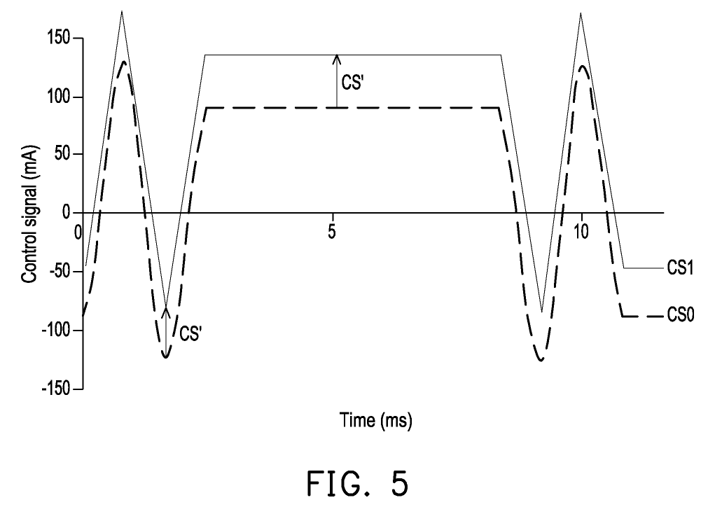

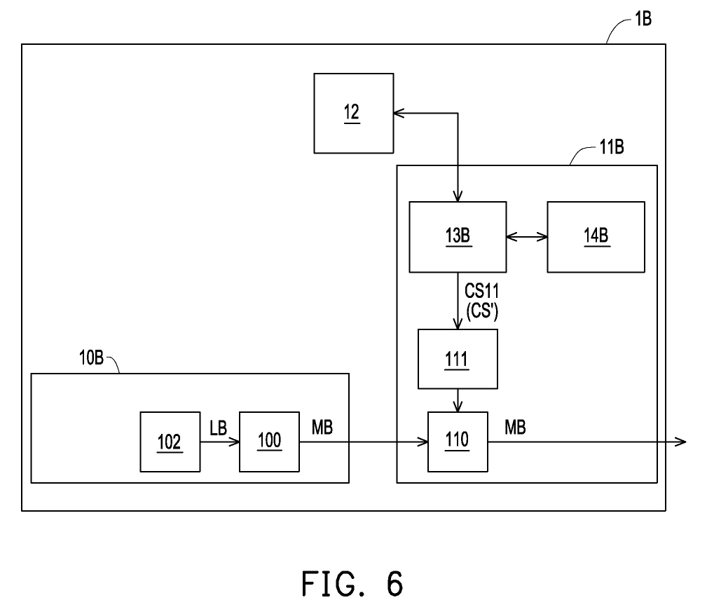

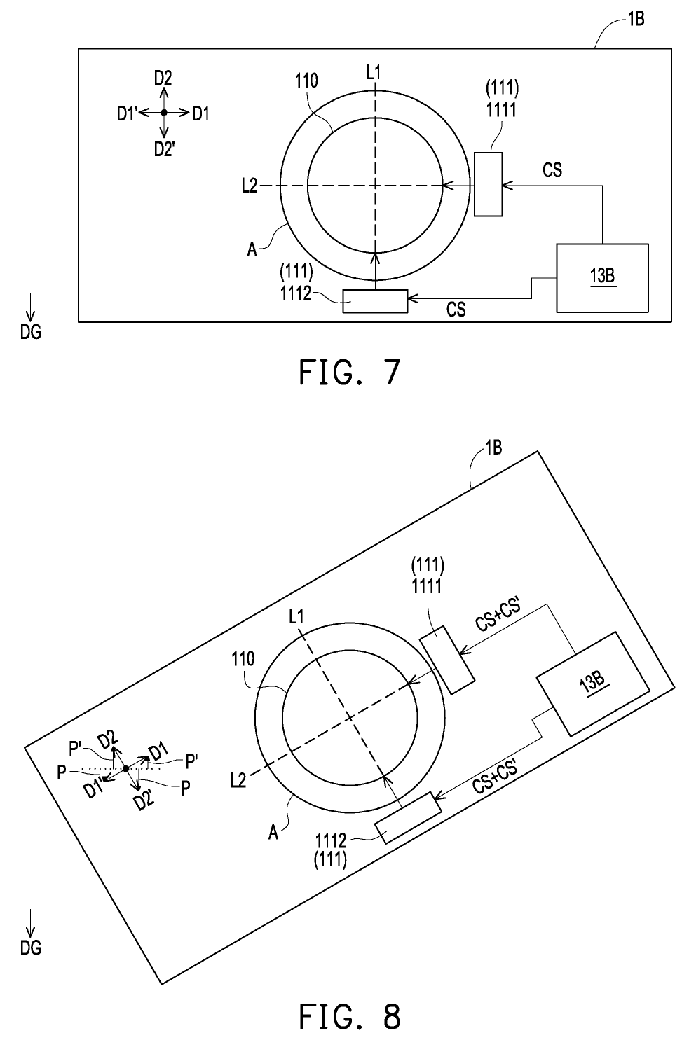

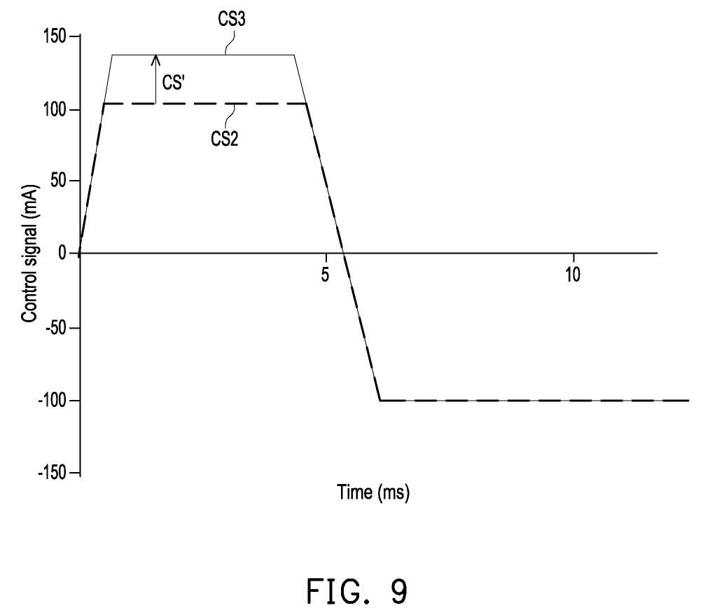

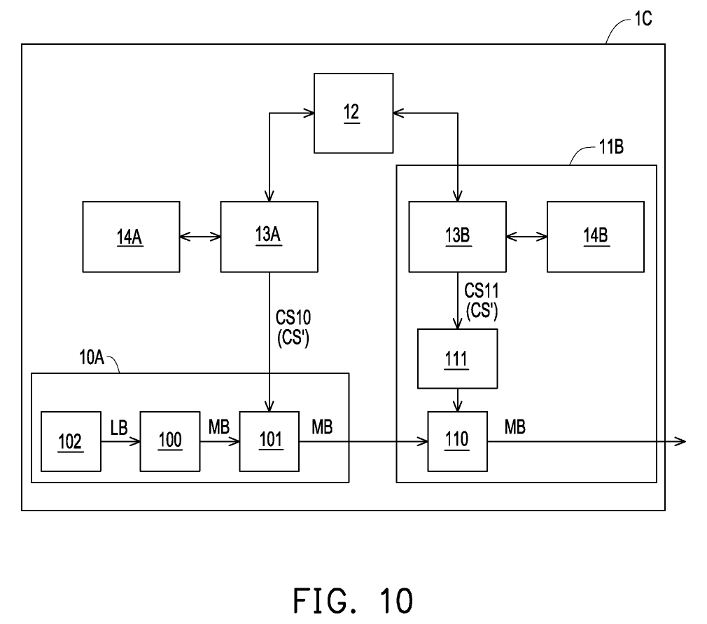

FIG. 1 is a block diagram of a projection device according to some embodiments of the invention. FIG. 2 is a block diagram of another projection device according to some embodiments of the invention. FIG. 3 and FIG. 4 are respectively schematic diagrams of two orientation statuses of the projection device in FIG. 2. FIG. 5 is a schematic diagram of a control signal provided to a driving element of an actuator. FIG. 6 is a block diagram of another projection device according to some embodiments of the invention. FIG. 7 and FIG. 8 are respectively schematic diagrams of two orientation statuses of the projection device in FIG. 6. FIG. 9 is a schematic diagram of control signals provided to driving motors of the lens adjustment module. FIG. 10 is a block diagram of yet another projection device according to some embodiments of the invention.

Referring to FIG. 1 first, the projection device 1 may include an optical engine module 10, a projection lens module 11, a sensor 12 and at least one processor 13. The optical engine module 10 is configured to provide an image beam MB. The projection lens module 11 is disposed on a transmission path of the image beam MB from the optical engine module 10, and is configured to project the image beam MB out of the projection device 1. The projection lens module 11 includes a projection lens 110 and a lens adjustment module 111. The lens adjustment module 111 is configured to adjust a position of the projection lens 110. The sensor 12 is configured to sense an orientation status of the projection device 1. The at least one processor 13 is coupled to the sensor 12 and coupled to at least one of the optical engine module 10 and the lens adjustment module 111. The at least one processor 13 is configured to adjust a control signal provided to at least one of the optical engine module 10 and the lens adjustment module 111 according to the orientation status of the projection device 1.

The image beam MB provided by the optical engine module 10 is, for example, a beam with display information (for example, pattern and/or color). Details of the optical engine module 10 will be described later with reference to FIG. 2 or FIG. 6.

The projection lens module 11 is configured to project the image beam MB to a projection target, for example, to a projection screen or a wall. The projection lens 110 may include one or a plurality of lenses. In an embodiment, the projection lens 110 includes a combination of one or a plurality of optical lenses with refractive power, for example, various combinations of non-planar lenses such as a biconcave lens, a biconvex lens, a concavo-convex lens, a convexo-concave lens, a plano-convex lens, a plano-concave lens, etc. In an embodiment, the projection lens 110 may also include planar optical lenses. Here, the type and kind of the projection lens 110 are not limited by the embodiment. The lens adjustment module 111 may include a plurality of driving motors used for adjusting a position of the projection lens 110, which will be described later with reference to FIG. 7 or FIG. 8.

The sensor 12 may include at least one of an acceleration sensor (for example, a gravity sensor or a gyroscope) and a camera module (for example, a camera). In an embodiment, the sensor 12 may be an acceleration sensor, for example. When the orientation status of the projection device 1 changes, a mechanical component in the acceleration sensor (for example, a structure with a movable mass or an elastic structure) is displaced due to acceleration, and an internal sensing element (for example, a piezoelectric material or a capacitive sensing element) converts a displacement signal into an electrical signal, thereby calculating a direction and magnitude of the acceleration, or gravity information (for example, a three-axis acceleration value, a gravity vector, etc.), so as to measure the orientation status of the projection device 1. A signal corresponding to the orientation status of the projection device 1 may be transmitted to the at least one processor 13 through a connection device. The connection device may include an inter-integrated circuit (I²C) or a serial peripheral interface (SPI). In an embodiment, the sensor 12 may be, for example, a camera module, and the camera module may be disposed inside or outside the projection device 1. The camera module may capture an image of an external environment or a projected image, and perform image analysis through the at least one processor 13 to determine the orientation status of the projection device 1. For example, when the at least one processor 13 analyzes the image captured by the camera module, the at least one processor 13 may determine the orientation status of the projection device 1 based on a skew degree of the image of the external environment or a deformation degree of the projected image (for example, deformed from a rectangle to a trapezoid).

The at least one processor 13 may include a field programmable gate array (FPGA), a microcontroller (MCU), or other devices with computing processing capabilities. A number of the processors 13 may be one or plural. The at least one processor 13 may calculate the influence of gravity on at least one of the optical engine module 10 and the lens adjustment module 111 according to the orientation status of the projection device 1 that is sensed by the sensor 12, and accordingly adjust the control signal provided to at least one of the optical engine module 10 and the lens adjustment module 111. Details will be described later with reference to FIG. 3 to FIG. 4 or FIG. 7 to FIG. 8.

FIG. 1 schematically illustrates one processor 13, the processor 13 is coupled to both of the optical engine module 10 and the lens adjustment module 111, and the processor 13 is configured to adjust at least one of a control signal CS10 provided to the optical engine module 10 and a control signal CS11 provided to the lens adjustment module 111 according to the orientation status of the projection device 1. In the embodiment, the number of the at least one processor in the projection device 1 may be changed according to actual needs. Taking FIG. 10 as an example, the number of the at least one processor may be greater than one, for example, the at least one processor may include a first processor 13A and a second processor 13B. In addition, the processor may be coupled to only one of the optical engine module 10 and the lens adjustment module 111, and may adjust the control signal provided to only one of the optical engine module 10 and the lens adjustment module 111 according to the orientation status of the projection device 1, as shown in FIG. 2 or FIG. 6.

In the following embodiments, the same or similar elements are represented by the same or similar referential numbers, and descriptions thereof are not repeated.

Referring to FIG. 2, in the projection device 1A, the optical engine module 10A may include a light valve 100 and an actuator 101, where the light valve 100 is configured to convert the illumination beam LB into an image beam MB, and the actuator 101 is disposed on a transmission path of the image beam MB from the light valve 100 to control the transmission path of the image beam MB from the light valve 100. The projection lens 110 is disposed on the transmission path of the image beam MB from the actuator 101.

In some embodiments, as shown in FIG. 2, the optical engine module 10A may also include an illumination system 102. The illumination system 102 is configured to provide the illumination beam LB. Although not shown in FIG. 2, the illumination system 102 may include, for example, a light source, a light guide element, a light wavelength conversion module, and/or a light uniforming element, but the invention is not limited thereto. The light source may include one or a plurality of light-emitting elements, such as laser diodes, light-emitting diodes, or a combination of the above. The light guide element is disposed on the transmission path of the light beam from the light source and may include a reflector, a prism, a dichroic element, or other elements that may change the transmission path of the light beam. The light wavelength conversion module is disposed on the transmission path of the light beam from the light guide element, and may be, for example, a phosphor wheel or other light conversion element. The light uniforming element is disposed on the transmission path of the light beam from the light wavelength conversion module to improve uniformity of the illumination beam LB output from the illumination system 102. For example, the light uniforming element may include a light integration rod or a lens array, but the invention is not limited thereto.

The light valve 12 is disposed on the transmission path of the illumination beam LB from the illumination system 102. For example, the light valve 12 may be a digital micro-mirror device (DMD), a liquid-crystal-on-silicon panel (LCOS panel) or a transmissive liquid crystal panel, but the invention is not limited thereto.

The actuator 101 is disposed on the transmission path of the image beam MB from the light valve 100 to control the transmission path of the image beam MB from the light valve 100. An optical element in the actuator 101 (for example, an optical element 1010 of FIG. 3) may swing back and forth based on each actuation axis, so that the image beam MB generates a plurality of light spots moving along multiple paths on a virtual plane, thereby forming a plurality of pixels. By moving the light spots formed by the image beam MB on the virtual plane between a plurality of positions, positions of each of the pixels of the projected image are shifted, thereby further increasing a resolution of the projected image. The actuator 101 may be disposed between the light valve 100 and the projection lens 110, or may be disposed within the projection lens module 11.

When the orientation status of the projection device 1A changes, as shown in FIG. 3 and FIG. 4, the optical element in the actuator 101 (for example, the optical element 1010 of FIG. 3) may be shifted due to the influence of gravity, which causes problems such as distortion, blur and/or offset of the projected image. In the embodiment, as shown in FIG. 2, the at least one processor may include a first processor 13A coupled to the sensor 12 and the actuator 101. The first processor 13A may be, for example, a field programmable gate array, and the first processor 13A may be, for example, disposed on a main circuit board of the projection device 1A. By using the first processor 13A to adjust the control signal CS10 provided to the actuator 101 of the optical engine module 10A according to the orientation status of the projection device 1A, the influence of gravity on the actuator 101 may be compensated, so that the transmission path of the image beam MB output by the optical engine module 10A is in line with expectations, which will be described later with reference to FIG. 3 or FIG. 4. In FIG. 3 and FIG. 4, for the sake of simplicity of the drawings, only a light outlet A, the actuator 101 and the first processor 13A of the projection device 1A are schematically shown, and the remaining components of the projection device 1A are omitted. The image beam MB from the projection lens 110 may leave the projection device 1A through the light outlet A and may be transmitted to a projection target.

Referring to FIG. 3 or FIG. 4, the actuator 101 may include an optical element 1010 and a plurality of driving elements (for example, a first driving element 1011 and a second driving element 1012). The actuator 101 has a first axis L1 (actuating axis) and a second axis L2 (actuating axis). The first driving element 1011 is provided on the second axis L2, and the second driving element 1012 is provided on the first axis L1. The plurality of driving elements are configured to drive the optical element 1010 to swing back and forth along the first axis L1 and the second axis L2, where the first axis L1 and the second axis L2 are perpendicular to each other, and when the orientation status of the projection device 1A is a in horizontal orientation relative to a direction of gravity DG (as shown in FIG. 3, for example, an upper cover and a lower cover of the projection device 1A are perpendicular to the direction of gravity DG), an intersection of the first axis L1 and the second axis L2 is, for example, a geometric center of the optical element 1010.

The optical element 1010 may be, for example, a light-transmitting element or a reflective element. The optical element 1010 may allow the image beam MB from the light valve 100 to pass through, or the optical element 1010 may reflect the image beam MB from the light valve 100. For example, the optical element 1010 may include a lens (for example, a light-transmitting sheet or a reflector).

The plurality of driving elements include, for example, a plurality of coils. By changing a current magnitude and/or a time applied to individual coils, a vibration amplitude and vibration frequency of the optical element 1010 may be changed.

In some embodiments, as shown in FIG. 3 or FIG. 4, the plurality of driving elements may include the first driving element 1011 configured to drive the optical element 1010 to swing back and forth along the first axis L1 (for example, a direction D1 and its opposite direction D1' may be an equilibrium vector for the swing of the optical element 1010 relative to the first axis L1) and the second driving element 1012 configured to drive the optical element 1010 to swing back and forth along the second axis L2 (for example, a direction D2 and its opposite direction D2' may be an equilibrium vector for the swing of the optical element 1010 relative to the second axis L2). In response to the orientation status of the projection device 1A being a tilted orientation relative to the direction of gravity DG (as shown in FIG. 4 , for example, the upper cover and the lower cover of the projection device 1A are not perpendicular to the direction of gravity DG), the at least one processor (for example, the first processor 13A) is configured to generate a compensation signal CS' provided to at least one of the first driving element 1011 and the second driving element 1012 according to deviation of the tilted orientation relative to the direction of gravity DG, and the control signal CS10 includes the compensation signal CS'.

FIG. 3 and FIG. 4 schematically illustrate a shape of the optical element 1010 to be a rectangle, and the plurality of driving elements include two first driving elements 1011 and two second driving elements 1012, and the two first driving elements 1011 are respectively arranged adjacent to two short sides of the optical element 1010, and the two second driving elements 1012 are respectively arranged adjacent to two long sides of the optical element 1010. However, it should be understood that the shape of the optical element 1010, the number of the driving elements, and/or a mutual arrangement relationship between the driving elements and the optical element 1010 may be changed according to actual needs, and are not limited to the examples shown in FIG. 3 or FIG. 4. For example, although not shown, the shape of the optical element 1010 may be a square. For example, although not shown, the number of the plurality of driving elements may be two, and the two driving elements may be disposed on two opposite sides of the optical element 1010. For example, although not shown, the number of the plurality of driving elements may be six, eight, or more, and the plurality of driving elements may be disposed along diagonals and/or sides of the optical element 1010.

When the equilibrium vector (for example, the direction D1, the direction D1', the direction D2 or the direction D2') for the swing of the optical element 1010 relative to the first axis L1 and/or the second axis L2 is the same as the direction of gravity DG or when the equilibrium vector for the swing of the optical element 1010 relative to the first axis L1 and/or the second axis L2 has a component P in the same direction as the direction of gravity DG, the at least one processor (for example, the first processor 13A) is configured to generate a compensation signal of reduced magnitude CS' provided to the first driving element 1011 and/or the second driving element 1012. On the other hand, when the equilibrium vector for the swing of the optical element 1010 relative to the first axis L1 and/or the second axis L2 is opposite to the direction of gravity DG or when the equilibrium vector for the swing of the optical element 1010 relative to the first axis L1 or the second axis L2 has a component P' in the opposite direction to the direction of gravity DG, the at least one processor (for example, the first processor 13A) is configured to generate a compensation signal of amplified magnitude CS' provided to the first driving element 1011 and/or the second driving element 1012. In some embodiments, as shown in FIG. 5, the compensation signal CS' includes an absolute value of the current signal.

FIG. 5 schematically illustrates one pulse-width modulation (PWM) signal provided to the second driving element 1012. The PWM signal is configured to control the operation of the actuator 101. For example, the PWM signal may control a position or a moving speed of the optical element 1010 in the actuator 101. The PWM signal includes a current compensation value (compensation signal CS'). The current compensation value is configured to compensate for current deviations caused by environmental changes (for example, changes in the orientation status of the projection device 1A).

A waveform CS0 in FIG. 5 is an original current, and a waveform CS1 is a compensated current. It is assumed that the current in FIG. 5 corresponds to the operation of the second driving element 1012, and a positive current may swing the optical element 1010 in a positive direction of an actuation axis, for example, to swing from the direction D2 to a direction extending into the paper (i.e., the positive current may rotate the optical element 1010 in a clockwise direction along the first axis L1), while a negative current may swing the optical element 1010 in a negative direction of the actuation axis, for example, to swing from the direction D2' to the direction extending into the paper (i.e., the negative current may rotate the optical element 1010 in a counterclockwise direction along the first axis L1). When the equilibrium vector of the swing of the optical element 1010 is the same as the direction of gravity DG or has a component in the same direction as the direction of gravity DG, the current is reduced (for example, an absolute value of the negative current is reduced) to alleviate a pulling force that swings the optical element 1010 from the direction D2' to the direction of extending into the paper surface; conversely, when the equilibrium vector of the swing of the optical element 1010 is opposite to the direction of gravity DG or has a component in the opposite direction of the direction of gravity DG, the current is increased to increase a pushing force that swings the optical element 1010 from the direction D2 to the direction of extending into the paper surface. In this way, the forces acting in upward and downward directions may be balanced to reduce the influence of gravity on the swing of the optical element 1010.

Taking FIG. 3 as an example, when the sensor 12 (shown in FIG. 2) confirms that the orientation status of the projection device 1A is a horizontal orientation (preset status) with respect to the direction of gravity DG, the first processor 13A may not compensate the control signal CS10 provided to the first driving elements 1011 and the second driving elements 1012, i.e., the control signal CS10 provided by the first processor 13A to the first driving elements 1011 and the second driving elements 1012 is an original control signal CS. In some embodiments, for example, during a production test stage (before the horizontal orientation is set as the preset status), the operation of the second driving elements 1012 arranged along the first axis L1 is affected by gravity, and the operation of the first driving elements 1011 arranged along the second axis L2 is not affected by gravity. Under such configuration, the first processor 13A may generate a compensation signal CS' (current compensation value) provided to the second driving element 1012, so that the compensated control signal (for example, the control signal CS10 shown in FIG. 2) that the first processor 13A provides to the second driving element 1012 is, for example, the original control signal CS plus the compensation signal CS'. On the other hand, since the operation of the first driving element 1011 is not affected by gravity, i.e., the equilibrium vector for the swing of the optical element 1010 relative to the first axis L1 is not parallel to the direction of gravity DG and the equilibrium vector for the swing of the optical element 1010 relative to the first axis L1 has no component parallel to the direction of gravity DG, the first processor 13A may not compensate the control signal CS10 provided to the first driving element 1011, i.e., the control signal CS10 provided to the first driving element 1011 by the first processor 13A is the original control signal CS.

Taking FIG. 4 as an example, when the sensor 12 (shown in FIG. 2) confirms that the orientation status of the projection device 1A is a tilted orientation relative to the direction of gravity DG, the compensation signal CS10 provided to the first driving elements 1011 and/or the second driving elements 1012 by the first processor 13A may be compensated based on an additional influence of gravity on the orientation status of the projection device 1A relative to the horizontal orientation (preset status), i.e. the signal provided by the first processor 13A to the first driving elements 1011 and the second driving elements 1012 when the projection device 1A is in the horizontal orientation is the (original) control signal CS, and when the orientation status of the projection device 1A is the tilted orientation, the first processor 13A may obtain the compensation signal CS' provided to the first driving elements 1011 and/or the second driving elements 1012 based on a gravity deviation between the preset status and the tilted orientation. In an embodiment, for example, when the horizontal orientation is not set as the preset status, the first processor 13A may generate the compensation signal CS' based on whether the first driving elements 1011 and/or the second driving elements 1012 are affected by gravity. For example, the operation of the second driving elements 1012 arranged along the first axis L1 and the operation of the first driving elements 1011 arranged along the second axis L2 are both affected by gravity. In FIG. 4, an operation (balance) direction of the first driving elements 1011 (here, the direction D1 and the direction D1' are taken as the operation balance direction in which the first driving elements 1011 drive the optical element 1010 to swing relative to the first axis L1) has a component (including the component P' in the opposite direction to the direction of gravity DG and the component P in the same direction as the direction of gravity DG) parallel to the direction of gravity DG, and an operation (balance) direction of the second driving elements 1012 (here, the direction D2 and the direction D2' are taken as the operation balance direction in which the second driving elements 1012 drive the optical element 1010 to swing relative to the second axis L2) has a component (including the component P' in the opposite direction to the direction of gravity DG and the component P in the same direction as the direction of gravity DG) parallel to the direction of gravity DG. Under such configuration, the first processor 13A may generate the compensation signal CS' provided to the first driving elements 1011 and the compensation signal CS' provided to the second driving elements 1012, where the compensation signal CS' provided to the first driving elements 1011 may be the same as or different from the compensation signal CS' provided to the second driving elements 1012. For example, when the influence of gravity on the second driving elements 1012 is greater than the influence of gravity on the first driving elements 1011, for example, when a gravity component of an operation direction of the second driving elements 1012 (for example, the component P' corresponding to the direction D2 and the component P corresponding to the direction D2' in FIG. 4) is greater than a gravity component of an operation direction of the first driving elements 1011 (for example, the component P' corresponding to the direction D1 and the component P corresponding to the direction D1' in FIG. 4), the compensation signal CS' provided to the second driving elements 1012 may be greater than the compensation signal CS' provided to the first driving elements 1011.

In some embodiments, as shown in FIG. 2, the projection device 1A may further include a first memory 14A. The first memory 14A is configured to store a first lookup table, upon reading the orientation status from the sensor 12, the at least one processor (for example, the first processor 13A) provides the corresponding compensation signal CS' to at least one of the plurality of driving elements of the actuator 101 according to the first lookup table. In some embodiments, the first memory 14A may be a random-access memory (RAM) or other types of memory. In some embodiments, although not shown in FIG. 2, the first memory 14A may be integrated into the first processor 13A. In some embodiments, the first lookup table may include experimental results obtained from previous batch tests. For example, during the production test stage, gravity compensation may be performed for various orientation statuses of the projection device 1A, and the compensation signals corresponding to each of the orientation statuses may be recorded when a pixel offset of the projected image is confirmed to be normal after the compensation, and the batch data obtained from multiple projection devices 1A may then be averaged to serve as a reference basis for table lookup.

Referring to FIG. 6, in a projection device 1B, an optical engine module 10B, for example, does not include the actuator 101 of FIG. 2, and the projection lens 110 is disposed on the transmission path of the image beam MB from the light valve 100. The at least one processor includes a second processor 13B coupled to the sensor 12 and the lens adjustment module 111. In some embodiments, the second processor 13B may be, for example, a microcontroller. In some embodiments, as shown in FIG. 6, the second processor 13B may be disposed in the projection lens module 11B. In other embodiments, although not shown, the second processor 13B may alternatively be disposed outside the projection lens module 11B.

When the orientation status of the projection device 1B changes, as shown in FIG. 7 and FIG. 8, gravity may increase or decrease a force that the driving motors (for example, a first driving motor 1111 and a second driving motor 1112) in the lens adjustment module 111 need to overcome to move the projection lens 110, i.e., gravity may produce different loads on the lens adjustment module 111, and with different loads, the time required to move the projection lens 110 may also vary. If the driving motors often operate under heavy load, wearing of a mechanical structure (especially a contact surface between the driving motor and a gear) will be aggravated over time, thereby shortening a service life of the components. Gravity may affect friction of an internal mechanism in the lens adjustment module 111. As the orientation status of the projection device 1B changes, the friction may increase or decrease, thereby affecting a smoothness of the motor movement. Especially, when the projection lens 110 moves in a direction parallel to the direction of gravity DG, changes in the friction may make the driving motor difficult to accurately maintain stability of the projection lens 110 at certain positions. In the embodiment, as shown in FIG. 6, by using the second processor 13B to adjust the control signal CS11 provided to the lens adjustment module 111 according to the orientation status of the projection device 1B, the influence of gravity on the lens adjustment module 111 may be compensated, so that the transmission path of the image beam MB output from the projection lens module 11B is as expected, which will be described later with reference to FIG. 7 or FIG. 8. In FIG. 7 and FIG. 8, for simplicity of the drawings, only the light outlet A, the projection lens 110, the lens adjustment module 111 and the second processor 13B are schematically shown, and the other components of the projection device 1B are omitted.

Referring to FIG. 7 or FIG. 8, the lens adjustment module 111 may include a first driving motor 1111 and a second driving motor 1112. The first driving motor 1111 has a longitudinal operating screw configured to adjust the movement of the projection lens 110 in a direction parallel to the first axis L1 (for example, the direction D2 or the direction D2'), and the second driving motor 1112 has a lateral operating screw for adjusting the movement of the projection lens 110 in a direction parallel to the second axis L2 (for example, the direction D1 or the direction D1'). The first axis L1 and the second axis L2 are perpendicular to each other, and when the orientation status of the projection device 1B is a horizontal orientation relative to the direction of gravity DG (as shown in FIG. 7), the first axis L1 is parallel to the direction of gravity DG.

In some embodiments, as shown in FIG. 8, in response to the orientation status of the projection device 1B being a tilted orientation relative to the direction of gravity DG, the at least one processor (for example, the second processor 13B) is configured to generate a compensation signal CS' provided to at least one of the first driving motor 1111 and the second driving motor 1112 according to the deviation of the tilted orientation relative to the direction of gravity DG, where the control signal CS11 includes the compensation signal CS'.

When a moving direction of the projection lens 110 (for example, the direction D1, the direction D1', the direction D2 or the direction D2') is opposite to the direction of gravity DG or when the moving direction of the projection lens 110 has a component P' in the direction opposite to the direction of gravity DG, the at least one processor (for example, the second processor 13B) is configured to generate the compensation signal CS' of amplified magnitude provided to at least one of the first driving motor 1111 and the second driving motor 1112. In some embodiments, as shown in FIG. 9, the compensation signal CS' includes an absolute value of the current signal.

FIG. 9 schematically illustrates one of the control signals provided to the first driving motor 1111. The control signal may control a moving direction or moving speed of the projection lens 110. The control signal may include a current compensation value (compensation signal CS'). The current compensation value is configured to compensate for current deviations caused by environmental changes (for example, changes in the orientation status of the projection device 1B).

A waveform CS2 in FIG. 9 is an original current, and a waveform CS3 is a compensated current. It is assumed that the current in FIG. 9 corresponds to the operation of the first driving motor 1111, a positive current may move the projection lens 110 in the direction D2 (i.e., when the projection device 1A is in the horizontal orientation, the positive current may push the projection lens 110 upward), and a negative current may move the projection lens 110 in the direction D2' (i.e., when the projection device 1A is in the horizontal orientation, the negative current may pull the projection lens 110 downward). When the moving direction of the projection lens 110 is opposite to the direction of gravity DG or has a component in the opposite direction of the direction of gravity DG, the current is increased to increase a pushing force to move the projection lens 110 in the direction D2. On the other hand, when the moving direction of the projection lens 110 is the same as the direction of gravity DG or has a component in the same direction as the direction of gravity DG, since the movement of the projection lens 110 in the direction of gravity DG does not need to additionally overcome the influence of gravity, a magnitude of the negative current may remain changed. By increasing the positive current that pushes the projection lens 110 upward in the direction D2, a lifting time and a lowering time of the projection lens 110 may be consistent, which improves operation smoothness of the driving motor and reduces the negative influence of gravity.

Taking FIG. 7 as an example, when the sensor 12 (shown in FIG. 2) confirms that the orientation status of the projection device 1B is the horizontal orientation (preset status) relative to the direction of gravity DG, the second processor 13B may not compensate the control signal CS provided to the first driving motor 1111 and the second driving motor 1112, i.e., the control signal CS11 provided to the first driving motor 1111 and the second driving motor 1112 by the second processor 13B is the original control signal CS. In some embodiments, for example, during the production test stage (before the horizontal orientation is set as the preset status), the operation of the first driving motor 1111 is affected by gravity, while the operation of the second driving motor 1112 is not affected by gravity. Under such configuration, the second processor 13B may generate the compensation signal CS' (current compensation value) provided to the first driving motor 1111, so that the compensated control signal (for example, the control signal CS11 shown in FIG. 6) that the second processor 13B may provide to the first driving motor 1111 is, for example, the original control signal CS plus the compensation signal CS'. On the other hand, since the operation of the second driving motor 1112 is not affected by gravity, i.e., the moving direction (including the direction D1 and the direction D1' shown in FIG. 7) of the projection lens 110 driven by the second driving motor 1112 is not parallel to the direction of gravity DG and the moving direction of the projection lens 110 does not have a component in the direction parallel to the direction of gravity DG, the second processor 13B may not compensate the control signal CS11 provided to the second driving motor 1112, i.e., the control signal CS11 provided to the second driving motor 1112 by the second processor 13B is the original control signal CS.

Taking FIG. 8 as an example, when the sensor 12 (shown in FIG. 6) confirms that the orientation status of the projection device 1B is the tilted orientation relative to the direction of gravity DG, the compensation signal CS' provided by the second processor 13B to the first driving motor 1111 and/or the second driving motor 1112 may be compensated based on an additional influence of gravity on the orientation status of the projection device 1B relative to the horizontal orientation (preset status), i.e., when the projection device 1B is in the horizontal orientation, the signal provided by the second processor 13B to the first driving motor 1111 and the second driving motor 1112 is the (original) control signal CS, and when the orientation status of the projection device 1B is the tilted orientation, the second processor 13B may obtain the compensation signal CS' provided to the first driving motor 1111 and/or the second driving motor 1112 based on gravity deviation between the preset status and the tilted orientation. In an embodiment, for example, when the horizontal orientation is not set to the preset status, the second processor 13B may generate the compensation signal CS' based on whether the first driving motor 1111 and/or the second driving motor 1112 are affected by gravity. For example, the operations of the first driving motor 1111 and the second driving motor 1112 are both affected by gravity. In FIG. 8, the operation direction of the first driving motor 1111 (including the direction D2) has a component P' in the direction opposite to the direction of gravity DG, and the operation direction (including the direction D1) of the second driving motor 1112 has the component P' in the direction opposite to the direction of gravity DG. Under such configuration, the second processor 13B may generate the compensation signal CS' provided to the first driving motor 1111 and the compensation signal CS' provided to the second driving motor 1112, where the compensation signal CS' provided to the first driving motor 1111 may be the same as or different from the compensation signal CS' provided to the second driving motor 1112. For example, when the second driving motor 1112 is less affected by gravity than the first driving motor 1111, for example, when a gravity component of the operation direction of the second driving motor 1112 (for example, the component P' corresponding to the direction D1 in FIG. 8) is smaller than the gravity component of the operation direction of the first driving motor 1111 (for example, the component P' corresponding to the direction D2 in FIG. 8), the compensation signal CS' provided to the second driving motor 1112 may be smaller than the compensation signal CS' provided to the first driving motor 1111.

In some embodiments, as shown in FIG. 6, the projection device 1B may further include a second memory 14B. The second memory 14B is configured to store the second lookup table. After reading the orientation status from the sensor 12, the at least one processor (for example, the second processor 13B) is configured to provide the corresponding compensation signal CS' to at least one of the first driving motor 1111 and the second driving motor 1112 of the lens adjustment module 111 according to the second lookup table. In some embodiments, the second memory 14B may be a random access memory or other types of memory. In some embodiments, as shown in FIG. 6, the second memory 14B may be disposed in the projection lens module 11B. In some embodiments, although not shown in FIG. 6, the second memory 14B may be integrated into the second processor 13B. In some embodiments, the second lookup table may include previous batch experiment results. For example, during the production test stage, gravity compensation may be performed for various orientation statuses of the projection device 1B, and the compensation signals corresponding to each of the orientation statuses may be recorded when a load of the driving motor is confirmed to be normal after the compensation. The batch data of multiple projection devices 1B may then be averaged to serve as a basis for table lookup.

Referring to FIG. 10, the projection device 1C may include the aforementioned optical engine module 10A, the projection lens module 11B, the sensor 12, the first processor 13A, the first memory 14A, the second processor 13B, and the second memory 14B. For details of the optical engine module 10A, the projection lens module 11B, the sensor 12, the first processor 13A, the first memory 14A, the second processor 13B and the second memory 14B, reference may be made to the aforementioned descriptions, which will not be repeated.

In summary, the embodiments of the invention have at least one of the following advantages or effects. In an embodiment of the invention, the at least one processor adjusts the control signal provided to at least one of the optical engine module and the lens adjustment module according to the orientation status of the projection device, thereby mitigating a negative influence on the optical engine module and/or the lens adjustment module caused by changes in the orientation status.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their

broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising:
an optical engine module, configured to provide an image beam;
a projection lens module, disposed on a transmission path of the image beam from the optical engine module, configured to project the image beam out of the projection device, and the projection lens module comprising:
a projection lens; and
a lens adjustment module, configured to adjust a position of the projection lens;
a sensor, configured to sense an orientation status of the projection device; and
at least one processor, coupled to the sensor, and coupled to at least one of the optical engine module and the lens adjustment module, the at least one processor being configured to adjust a control signal provided to at least one of the optical engine module and the lens adjustment module according to the orientation status of the projection device.

2. The projection device as claimed in claim 1, wherein the sensor comprises at least one of an acceleration sensor and a camera module.

3. The projection device as claimed in claim 1, wherein the optical engine module comprises a light valve and an actuator, the light valve is configured to convert an illumination beam into the image beam, the actuator is disposed on a transmission path of the image beam from the light valve to control the transmission path of the image beam from the light valve.

4. The projection device as claimed in claim 3, wherein the at least one processor comprises a first processor coupled to the sensor and the actuator.

5. The projection device as claimed in claim 4, wherein the first processor comprises a field programmable gate array.

6. The projection device as claimed in claim 3, wherein the actuator comprises an optical element and a plurality of driving elements, the plurality of driving elements are configured to drive the optical element to swing back and forth with respect to a first axis and a second axis, the first axis and the second axis are perpendicular to each other, and when the orientation status of the projection device is a horizontal orientation relative to a direction of gravity, the first axis is parallel to the direction of gravity.

7. The projection device as claimed in claim 6, wherein the plurality of driving elements comprise a first driving element configured to drive the optical element to swing back and forth with respect to the first axis and a second driving element configured to drive the optical element to swing back and forth with respect to the second axis, wherein in response to the orientation status of the projection device being a tilted orientation relative to the direction of gravity, the at least one processor is configured to generate a compensation signal provided to at least one of the first driving element and the second driving element according to deviation of the tilted orientation relative to the direction of gravity, wherein the control signal comprises the compensation signal.

8. The projection device as claimed in claim 6, wherein the plurality of driving elements comprise a first driving element configured to drive the optical element to swing back and forth with respect to the first axis and a second driving element configured to drive the optical element to swing back and forth with respect to the second axis, wherein when an equilibrium vector for the swing of the optical element relative to the first axis and/or the second axis is the same as the direction of gravity or when the equilibrium vector for the swing of the optical element relative to the first axis and/or the second axis has a component in the same direction as the direction of gravity, the at least one processor is configured to generate a compensation signal of reduced magnitude provided to the first driving element and/or the second driving element, and when the equilibrium vector for the swing of the optical element relative to the first axis and/or the second axis is opposite to the direction of gravity or when the equilibrium vector for the swing of the optical element relative to the first axis and/or the second axis has a component in a direction opposite to the direction of gravity, the at least one processor is configured to generate a compensation signal of amplified magnitude provided to the first driving element and/or the second driving element, wherein the control signal comprises the compensation signal.

9. The projection device as claimed in claim 7, wherein the compensation signal comprises an absolute value of a current signal.

10. The projection device as claimed in claim 6, further comprising:
a first memory, configured to store a first lookup table, wherein upon reading the orientation status from the sensor, the at least one processor is configured to provide a corresponding compensation signal to at least one of the plurality of driving elements of the actuator according to the first lookup table, wherein the control signal comprises the compensation signal.

11. The projection device as claimed in claim 1, wherein the at least one processor comprises a second processor coupled to the sensor and the lens adjustment module.

12. The projection device as claimed in claim 11, wherein the second processor comprises a microcontroller.

13. The projection device as claimed in claim 1, wherein the lens adjustment module comprises a first driving motor and a second driving motor, the first driving motor is configured to adjust movement of the projection lens in a direction parallel to a first axis, the second driving motor is configured to adjust movement of the projection lens in a direction parallel to a second axis, the first axis and the second axis are perpendicular to each other, and when the orientation status of the projection device is a horizontal orientation relative to a direction of gravity, the first axis is parallel to the direction of gravity.

14. The projection device as claimed in claim 13, wherein in response to the orientation status of the projection device being a tilted orientation relative to the direction of gravity, the at least one processor is configured to generate a compensation signal provided to at least one of the first driving motor and the second driving motor according to deviation of the tilted orientation relative to the direction of gravity, wherein the control signal comprises the compensation signal.

15. The projection device as claimed in claim 14, wherein the compensation signal comprises an absolute value of a current signal.

16. The projection device as claimed in claim 13, wherein when a moving direction of the projection lens is opposite to the direction of gravity or when the moving direction of the projection lens has a component in a direction opposite to the direction of gravity, the at least one processor is configured to generate a compensation signal of amplified magnitude provided to the first driving motor and/or the second driving motor, wherein the control signal comprises the compensation signal.

17. The projection device as claimed in claim 13, further comprising:
a second memory, configured to store a second lookup table, wherein upon reading the orientation status from the sensor, the at least one processor is configured to provide a corresponding compensation signal to at least one of the first driving motor and the second driving motor of the lens adjustment module according to the second lookup table, wherein the control signal comprises the compensation signal.
